(19) United States
(12) Patent Application Publication
(10) Pub. No.: US 2018/0370845 A1
(43) Pub. Date: Dec. 27, 2018

(54) CRYSTALLINE GLASS COMPOSITION

(71) Applicant: NIPPON ELECTRIC GLASS CO., LTD., Otsu-shi, Shiga (JP)

(72) Inventor: Yoshihisa TAKAYAMA, Otsu-shi (JP)

(21) Appl. No.: 16/062,670

(22) PCT Filed: Feb. 21, 2017
(86) PCT No.: PCT/JP2017/006417

§ 371 Date: Jun. 15, 2018

(30) Foreign Application Priority Data
Mar. 28, 2016 (JP) 2016-063227
Jun. 13, 2016 (JP) 2016-116785

(51) Int. Cl. C03C 8/24; H01M 8/0282

(52) U.S. Cl. CPC C03C 8/24; H01M 2008/1293; H01M 8/0282

(57) ABSTRACT

Provided is a crystallizable glass composition that has fluidity suitable for bonding, has a high coefficient of thermal expansion after undergoing thermal treatment, and has excellent thermal resistance after bonding. A crystallizable glass composition containing, in % by mole, over 57 to 80% SiO₂+CaO, over 0 to 40% MgO+BaO, over 10 to 40% ZnO, and over 0 to 15% La₂O₃.

### TECHNICAL FIELD

The present invention relates to crystallizable glass compositions and more particularly relates to a crystallizable glass composition used for the purpose of bonding metals, such as SUS or Fe, or high-expansion ceramics, such as ferrite or zirconia.

### BACKGROUND ART

Fuel cells have recently received attention as an important technique that can achieve high energy efficiency and significantly reduce emission of CO₂. The type of fuel cell is classified according to the electrolyte used. For example, fuel cells for industrial application fall into four types: a phosphoric-acid fuel cell (PAFC), a molten carbonate fuel cell (MCFC), a solid oxide fuel cell (SOFC), and a polymer electrolyte fuel cell (PEFC). Particularly, the solid oxide fuel cell (SOFC) is characterized in that the cell exhibits small internal resistance and therefore the highest power generation efficiency among the fuel cells, as well as that because there is no need to use any precious metal as a catalyst, its production costs can be kept down. For these reasons, the SOFC is a system widely applicable from small-scale applications, such as those for domestic use, to large-scale applications, such as a power plant, and expectations have been raised for its potential.

FIG. 1 shows the structure of a general planar SOFC. As shown in FIG. 1, a general planar SOFC includes a cell in which an electrolyte 1 made of a ceramic material, such as yttria-stabilized zirconia (YSZ), an anode 2 made of Ni/YSZ or the like, and a cathode 3 made of (La,Ca)CrO₃ or the like are layered and integrated. The planar SOFC further includes: a first support substrate 4 adjoining the anode 2 and having passages of fuel gas (fuel channels 4a) formed therein; and a second support substrate 5 adjoining the cathode 3 and having passage of air (air channels 5a) formed therein, wherein the first and second support substrates 4, 5 are fixed to the top and bottom, respectively, of the cell. The first support substrate 4 and the second support substrate 5 are made of metal, such as SUS, and fixed to the cell so that their gas passages are perpendicular to each other.

In the planar SOFC having the above structure, any of various gases, such as hydrogen (H₂), town gas, natural gas, biogas, and liquid fuel, is allowed to flow through the fuel channels 4a and concurrently air or oxygen (O₂) is allowed to flow through the air channels 5a. During this time, the cathode develops a reaction of ½O₂+2e⁻→O²⁻, while the anode develops a reaction of H₂+O²⁻→H₂O+2e⁻. These electrochemical reactions cause direct conversion of chemical energy to electrical energy, so that the planar SOFC can generate electric power. To provide high power, in an actual planar SOFC, many layers of structures shown in FIG. 1 are laid one on top of another.

In producing the above structure, its component members need to be hermetically sealed to each other so that the gas flowing through the anode side and the gas flowing through the cathode side are kept from becoming mixed with each other. For this purpose, a method is proposed for hermetically sealing the members by interlaying a sheet-shaped gasket made of an inorganic material, such as mica, vermiculite or alumina, between the members. However, this method is likely to cause a tiny amount of gas leakage, which presents a problem of decreased fuel use efficiency. To solve this problem, consideration has been given to a method for bonding the component members using a melt adhesive material made of glass.

Since high-expansion materials, such as metal and ceramic, are used as the component members of the structure, the adhesive material used also needs to have a coefficient of thermal expansion conforming to these high-expansion materials. Furthermore, the temperature range of the SOFC in which it develops the electrochemical reactions (i.e., the operating temperature range) is as high as 600 to 950° C. and the SOFC is operated in this temperature range over a long period. Therefore, the adhesive material is required to have high thermal resistance to avoid, even when exposed to high temperatures for a long period, deterioration in hermeticity and bondability due to melting of bonding portions.

Patent Literature 1 discloses, as a high-expansion adhesive material made of glass, a crystallizable glass composition that precipitates CaO—MgO—SiO₂-based crystals when undergoing thermal treatment and thus exhibits high expansion characteristics. Furthermore, Patent Literature 2 discloses a SiO₂—B₂O₃—SrO-based amorphous glass composition providing stable gas-sealing property.

### CITATION LIST

### Patent Literature

Patent Literature 1: WO 2009/017173

Patent Literature 2: JP-A-2006-56769

### SUMMARY OF INVENTION

### Technical Problem

The crystallizable glass composition described in Patent Literature 1 has high viscosity at high temperatures and is therefore less likely to soften and fluidize during thermal treatment, which makes it difficult to provide a dense sintered body. As a result, there arises a problem of difficulty in achieving stable sealing property. The amorphous glass composition disclosed in Patent Literature 2 has a glass transition point near 600° C. and therefore has a problem in that under a high-temperature operating environment at about 600 to about 800° C. the bonding portions will melt, thus failing to ensure hermeticity and bondability.

In view of the foregoing, the present invention has an object of providing a crystallizable glass composition that has fluidity suitable for bonding, has a high coefficient of thermal expansion after undergoing thermal treatment, and has excellent thermal resistance after bonding.

### Solution to Problem

The inventor has conducted various experiments and found from the results thereof that the above problems can be solved by a glass composition having a particular component composition.

Specifically, a crystallizable glass composition according to the present invention contains, in % by mole, over 57 to 80% SiO₂+CaO, over 0 to 40% MgO+BaO, over 10 to 40% ZnO, and over 0 to 15% La₂O₃. Herein, “SiO₂+CaO” means the sum of the contents of SiO₂ and CaO and “MgO+BaO” means the sum of the contents of MgO and BaO.

In the crystallizable glass composition according to the present invention, SiO₂ and CaO are components that increase fluidity and the definition of the sum of their contents as described above enables the provision of fluidity suitable for bonding (sealing). Furthermore, by restricting the contents of MgO, BaO, ZnO, and La₂O₃, which are components for precipitating high-expansion crystals through thermal treatment, as described above, bonding portions after the thermal treatment have a high coefficient of thermal expansion and good thermal resistance is also provided. Therefore, the bonding portions are less likely to melt even when used at high temperatures over a long period, so that the deterioration thereof in hermeticity and bondability can be reduced.

The term “crystallizable” herein means a property of the glass composition precipitating crystals from a glass matrix when undergoing thermal treatment. Furthermore, the term “thermal treatment” herein means to undergo thermal treatment under conditions of a temperature of 800° C. or above for 10 minutes or more.

The crystallizable glass composition according to the present invention is preferably substantially free of R₂O (where R represents an alkali metal) and P₂O₅. R₂O and P₂O₅ are likely to volatilize under thermal treatment and therefore may adversely affect the power generation property, such as decrease the electrical insulation of component members of the SOFC. Therefore, since the composition is substantially free of these components, an undue decrease of the power generation characteristics can be reduced. Note that “substantially free of” herein means that the component is not deliberately added and does not mean to exclude the incorporation of unavoidable impurities. Specifically, this means that the content of the relevant component is less than 0.1% by mole.

The crystallizable glass composition according to the present invention preferably precipitates crystals of at least one selected from the group consisting of MgO.SiO₂, BaO.2MgO.2SiO₂, 2SiO₂.2ZnO.BaO, and La₂O₃.2SiO₂ under thermal treatment. This composition enables the bonding portions to increase their expansibility and thermal resistance and, therefore, the crystallizable glass composition becomes suitable for use in bonding or coating between high-expansion materials, such as metal and ceramic.

The crystallizable glass composition according to the present invention preferably has a coefficient of thermal expansion of 85×10⁻⁷/° C. or more in a temperature range from 30 to 950° C.

The crystallizable glass composition according to the present invention preferably has a difference of 85° C. or more between a softening point thereof and a crystallization temperature thereof. If the crystallizable glass composition has a large difference between the softening point and the crystallization temperature, its crystallization becomes less likely to commence before it fluidizes, so that fluidity suitable for bonding becomes easy to achieve.

The crystallizable glass composition according to the present invention preferably contains, in % by mole, 40 to 70% SiO₂, 5 to 40% MgO, 5 to 40% BaO, over 10 to 40% ZnO, 3 to 30% CaO, and over 0 to 15% La₂O₃.

The crystallizable glass composition according to the present invention is suitable for bonding.

### Advantageous Effects of Invention

The crystallizable glass composition according to the present invention has fluidity suitable for bonding, has a high coefficient of thermal expansion after undergoing thermal treatment, and has excellent thermal resistance after bonding. Therefore, bonding portions are less likely to melt even when used at high temperatures over a long period, so that the deterioration thereof in hermeticity and bondability can be reduced.

### BRIEF DESCRIPTION OF DRAWINGS

FIG. 1 is a schematic perspective view showing the basic structure of an SOFC.

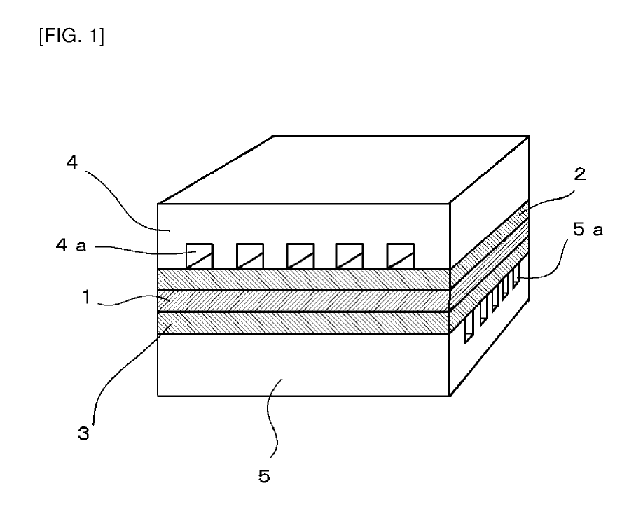

### DESCRIPTION OF EMBODIMENTS

A crystallizable glass composition according to the present invention contains, in % by mole, over 57 to 80% SiO₂+CaO, over 0 to 40% MgO+BaO, over 10 to 40% ZnO, and over 0 to 15% La₂O₃. The reasons why the glass component composition is defined as described above will be described below. Note that “%” used in the following description of the content of each component means “% by mole” unless otherwise stated.

SiO₂ and CaO are components for improving fluidity. The content of SiO₂+CaO is over 57 to 80%, preferably 57.1 to 78%, and particularly preferably 57.2 to 76%. If the content of SiO₂+CaO is too small, the fluidity suitable for bonding is difficult to achieve. On the other hand, if the content of SiO₂+CaO is too large, inconveniences are likely to occur, such as difficulty of precipitation of high-expansion crystals upon thermal treatment, difficulty of melting due to raised melting temperature, or ease of devitrification during melting.

Note that the preferred ranges of the contents of SiO₂ and CaO are as follows.

SiO₂ is a component for precipitating high-expansion crystals through thermal treatment and has, in addition to the effect of improving the fluidity, the effect of improving water resistance and thermal resistance. The SiO₂ content is 40 to 70%, preferably 41 to 69%, and particularly preferably 41 to 65%. If the SiO₂ content is too small, the fluidity suitable for bonding is difficult to achieve. On the other hand, if the SiO₂ content is too large, crystals are difficult to precipitate even when the glass composition undergoes the thermal treatment. In addition, meltability is likely to decrease.

The CaO content is 3 to 30%, preferably 3 to 29%, and particularly preferably 3 to 28%. If the CaO content is too small, the fluidity suitable for bonding is difficult to achieve. On the other hand, if the CaO content is too large, devitrification is likely to occur during melting.

MgO and BaO are components for precipitating high-expansion crystals through thermal treatment. The content of MgO+BaO is over 0 to 40%, preferably 1 to 39%, more preferably 2 to 38%, still more preferably 3 to 37%, yet still more preferably 5 to 37%, and particularly preferably 7 to 37%. If the content of MgO+BaO is too small, high-expansion crystals are difficult to precipitate when the glass composition undergoes the thermal treatment and the thermal resistance is likely to decrease. On the other hand, if the content of MgO+BaO is too large, the vitrification range tends to narrow, which makes devitrification likely to occur. In addition, the difference between the softening point and the crystallization temperature becomes small, which makes the fluidity likely to decrease.

The MgO content is 5 to 40%, preferably 5 to 39%, and particularly preferably 6 to 38%. The BaO content is 5 to 40%, preferably 5 to 39%, and particularly preferably 6 to 38%.

ZnO is a component for precipitating high-expansion crystals through thermal treatment. The ZnO content is over 10 to 40%, preferably 10.2 to 38%, more preferably 10.5 to 36%, and particularly preferably 10.5 to 34%. If the ZnO content is too small, high-expansion crystals are difficult to precipitate when the glass composition undergoes the thermal treatment and the thermal resistance is likely to decrease. On the other hand, if the ZnO content is too large, the vitrification range tends to narrow, which makes devitrification likely to occur. In addition, the difference between the softening point and the crystallization temperature becomes small, which makes the fluidity likely to decrease.

La₂O₃ is a component for precipitating high-expansion crystals through thermal treatment. In addition, La₂O₃ is a component for expanding the vitrification range to facilitate vitrification. The La₂O₃ content is over 0 to 15%, preferably 0.5 to 14%, and particularly preferably 1 to 13%. If the La₂O₃ content is too small, the above effect is difficult to achieve. On the other hand, if the La₂O₃ content is too large, the glass composition is likely to devitrify during melting or thermal treatment, so that the fluidity suitable for bonding is difficult to achieve.

The crystallizable glass composition according to the present invention may also contain TiO₂, ZrO₂, SnO₂, WO₃ or other components added thereto, each at a content of up to 2%, as components other than the foregoing components. However, because R₂O (where R represents an alkali metal) and P₂O₅ are likely to volatilize under thermal treatment and therefore may adversely affect the power generation property, such as decrease the electrical insulation of component members of the SOFC, the glass composition is preferably substantially free of these components.

The crystallizable glass composition of the present invention having the component composition as described above precipitates high-expansion crystals under the thermal treatment. An example of the high-expansion crystals is those of at least one selected from the group consisting of MgO.SiO₂, BaO.2MgO.2SiO₂, 2SiO₂.2ZnO.BaO, and La₂O₃.2SiO₂. The coefficient of thermal expansion of the crystallizable glass composition after the thermal treatment is preferably 85×10⁻⁷/° C. or more, more preferably 86×10⁻⁷/° C. or more, still more preferably 87×10⁻⁷/° C. or more, and particularly preferably 88×10⁻⁷/° C. or more. The crystallizable glass according to the present invention easily achieves a high crystallinity after undergoing the thermal treatment. In addition, the precipitated crystals have a high melting point and are therefore difficult to fluidize even when undergoing thermal treatment again, so that the thermal resistance can be maintained for a long period.

The difference between the softening point and the crystallization temperature of the crystallizable glass composition according to the present invention is preferably 85° C. or more, more preferably 90° C. or more, and still more preferably 95° C. or more. If the crystallizable glass composition has a small difference between the softening point and the crystallization temperature, its crystallization commences before it fluidizes, so that the fluidity decreases.

For the purpose of controlling the fluidity, a powder of magnesia (MgO), zinc oxide (ZnO), zirconia (ZrO₂), titania (TiO₂), alumina (Al₂O₃) or the like may be used by addition as a filler powder to the crystallizable glass composition according to the present invention. The amount of the filler powder added is, relative to 100 parts by mass of crystallizable glass composition, preferably 0 to 10 parts by mass, 0.1 to 9 parts by mass, and particularly preferably 1 to 8 parts by mass. If the amount of the filler powder added is too large, the fluidity is likely to decrease. The preferred filler powder to be used is one having a particle diameter of about 0.2 to about 20 μm in d50.

Next, a description will be given of a method for producing the crystallizable glass composition according to the present invention and an example of a method for using the crystallizable glass composition according to the present invention as an adhesive material.

First, a raw material powder prepared to have the component composition described above is melted at approximately 1400 to 1600° C. for about 0.5 to about 2 hours until homogeneous glass is obtained. Next, the molten glass is formed in a film shape or other shapes, ground, and classified to produce a glass powder made of the crystallizable glass composition according to the present invention. The glass powder preferably has a particle diameter (d50) of about 2 to about 20 μm. Various types of filler powders are added to the glass powder, if necessary.

Next, a vehicle is added to the glass powder (or a powder mixture of the glass powder and the filler powder) and they are kneaded to prepare a glass paste. The vehicle contains, for example, an organic solvent and a resin, as well as a plasticizer, a dispersant, and so on.

The organic solvent is a material for impasting the glass powder and, for example, terpineol (Ter), diethylene glycol monobutyl ether (BC), diethylene glycol monobutyl ether acetate (BCA), 2,2,4-trimethyl-1,3-pentanediol monoisobutyrate or dihydroterpineol can be used alone or as a mixture of them. The content of the organic solvent is preferably 10 to 40% by mass.

The resin is a component for increasing the strength of a film after being dried and for giving flexibility and the content thereof is generally about 0.1 to about 20% by mass. Examples of the resin that can be used include thermoplastic resins, specifically, polybutyl methacrylate, polyvinyl butyral, polymethyl methacrylate, polyethyl methacrylate, and ethyl cellulose and these compounds are used alone or as a mixture of them.

The plasticizer is a component for controlling the drying speed and giving flexibility to the dried film and the content thereof is generally about 0 to about 10% by mass. Examples of the plasticizer that can be used include butyl benzyl phthalate, dioctyl phthalate, diisooctyl phthalate, dicapryl phthalate, and dibutyl phthalate and these compounds are used alone or as a mixture of them.

Examples of the dispersant that can be used include ionic dispersants and non-ionic dispersants, the ionic dispersants that can be used include carboxylic acid-based dispersants, polycarboxylic acid-based dispersants, such as dicarboxylic acid-based dispersants, and amine-based dispersants, and the non-ionic dispersants that can be used include polyester condensate dispersants and polyol ether dispersants. The amount of the dispersant used is generally 0 to 5% by mass.

Next, the paste is applied to a bonding portion of a first member made of metal or ceramic and dried. Furthermore, a second member made of metal or ceramic is immobilized relative to the first member while in contact with the dried paste film and the dried paste film is then subjected to thermal treatment at 800 to 1050° C. Through this thermal treatment, the glass powder first softens and fluidizes to bond the first and second members together and precipitates crystals. In this manner, a joint body can be obtained which is formed so that the first member and the second member are bonded by a sealing portion made of the crystallizable glass composition according to the present invention.

The crystallizable glass composition according to the present invention can be used not only for bonding but also for other purposes, such as coating and filling. Furthermore, the crystallizable glass composition can also be used in forms other than a paste, specifically, such as a powder, a green sheet or a tablet. An exemplary form of usage is to fill a glass powder, together with a lead, in a cylinder made of metal or ceramic and subject it to thermal treatment to hermetically seal the cylinder and the lead. Alternatively, a preform formed in a green sheet, a tablet produced by powder press molding or the like may be put on a member made of metal or ceramic, subjected to thermal treatment, and thus softened and fluidized to coat the member.

### EXAMPLES

A description will be given below of the crystallizable glass composition according to the present invention with reference to examples but the present invention is not limited to the examples.

Tables 1 and 2 show examples of the present invention (Samples Nos. 1 to 9) and comparative examples (Samples Nos. 10 to 11).

TABLE 1

| Glass Composition (% by mole) | No. 1 | No. 2 | No. 3 | No. 4 | No. 5 | No. 6 |
|---|---|---|---|---|---|---|
| SiO₂ | 55 | 50 | 55 | 55 | 53 | 50 |
| MgO | 8 | 8 | 8 | 8 | 13 | 13 |
| BaO | 9 | 9 | 9 | 9 | 6 | 6 |
| ZnO | 18 | 18 | 13 | 18 | 18 | 18 |
| CaO | 5 | 10 | 10 | 8 | 5 | 8 |
| La₂O₃ | 5 | 5 | 5 | 2 | 5 | 5 |
| SiO₂ + CaO | 60 | 60 | 65 | 63 | 58 | 58 |
| MgO + BaO | 17 | 17 | 17 | 17 | 19 | 19 |
| Coefficient of Thermal | 112 | 96 | 88 | 102 | 114 | 99 |
| Expansion (×10⁻⁷/° C.) | | | | | | |
| Softening Point (° C.) | 846 | 835 | 851 | 839 | 847 | 839 |
| Crystallization Temperature (° C.) | 978 | 947 | 987 | 948 | 937 | 947 |
| (Crystallization Temp) − | 132 | 112 | 136 | 109 | 90 | 108 |
| (Softening Point) (° C.) | | | | | | |
| Fluidity | ⊚ | ⊚ | ⊚ | ◯ | ◯ | ⊚ |
| Precipitated Crystal | A, B, C, D | A, B, C, D | A, B, C, D | A, B, C, D | A, B, C, D | A, B, C, D |
| Crystalline Melting Point (° C.) | >1000 | >1000 | >1000 | >1000 | >1000 | >1000 |

TABLE 2

| Glass Composition | | | | | |
|---|---|---|---|---|---|
| (% by mole) | No. 7 | No. 8 | No. 9 | No. 10 | No. 11 |
| SiO₂ | 53 | 55 | 53 | 38 | 60 |
| MgO | 13 | 8 | 10 | 15 | 3 |
| BaO | 6 | 9 | 6 | 18 | 4 |
| ZnO | 16 | 16 | 18 | 15 | 4 |
| CaO | 7 | 7 | 8 | 10 | 21 |
| La₂O₃ | 5 | 5 | 5 | 4 | 8 |
| SiO₂+ CaO | 60 | 62 | 61 | 48 | 81 |
| MgO + BaO | 19 | 17 | 16 | 33 | 7 |
| Coefficient of Thermal | 109 | 100 | 105 | 113 | 56 |
| Expansion (×10⁻⁷/° C.) | | | | | |
| Softening Point (° C.) | 849 | 848 | 848 | 829 | 831 |
| Crystallization | 944 | 991 | 977 | 839 | — |
| Temperature (° C.) | | | | | |
| (Crystallization Temp.) − | 95 | 143 | 129 | 10 | — |
| (Softening Point) (° C.) | | | | | |
| Fluidity | ◯ | ⊚ | ⊚ | X | ⊚ |
| Precipitated Crystal | A, B, | A, B, | A, B, | A, B, | Net |
| | C, D | C, D | C, D | C, D | precipi- |
| | | | | | tated |
| Crystalline Melting | >1000 | >1000 | >1000 | >1000 | — |
| Point (° C.) | | | | | |

Each sample was produced in the following manner.

Each of raw materials prepared to have the component compositions shown in the above tables was melted at 1400 to 1600° C. for approximately an hour and the resultant melt was allowed to flow between a pair of rollers and thus formed in a film shape. The film-shaped formed body thus obtained was ground with a ball mill and classified to obtain a sample (crystallizable glass composition powder) having a particle diameter (d50) of approximately 10 μm.

The obtained samples were measured or evaluated in terms of coefficient of thermal expansion, softening point, fluidity, precipitated crystal, crystallization temperature, and crystalline melting point. The results are shown in Tables 1 and 2.

For the coefficient of thermal expansion, each sample was pressed into a shape and the pressed sample was subjected to thermal treatment at 1000° C. for three hours and then polished into the shape of a column of 4 mm diameter and 20 mm length. Using the measurement sample thus obtained, the value of coefficient of thermal expansion within a temperature range of 30 to 950° C. was found in accordance with JIS R3102.

The softening point, the crystallization temperature, and the crystalline melting point were measured with a macro differential thermal analyzer. Specifically, in a chart obtained by measuring each glass powder sample up to 1050° C. with the macro differential thermal analyzer, the value of a fourth inflection point was considered as the softening point, the value of a strong exothermic peak was considered as the crystallization temperature, and the value of an endothermic peak obtained after crystallization was considered as the crystalline melting point. Note that as the crystalline melting point is higher, this means the crystals more stably existing even at high temperatures and can provide the determination that the sample has higher thermal resistance.

The fluidity was evaluated in the following manner. The same amount of each glass powder sample as the specific gravity was loaded into a molding die of 20 mm diameter and pressed into a shape and the resultant formed body was fired at 850 to 1050° C. for 15 minutes on a SUS 430 plate. The formed bodies after being fired were evaluated by considering those having a flow button diameter of 18 mm or more as very good “double circle”, considering those having a flow button diameter of from 16 mm to below 18 mm as good “open circle”, and considering those having a flow button diameter of below 16 mm as poor “cross”.

The precipitated crystals were identified by subjecting each sample to an XRD (X-ray diffraction) measurement and comparing the measurement results with the JCPDS card. As the types of identified precipitated crystals, MgO.2SiO₂, BaO.2MgO.2SiO₂, 2SiO₂.2ZnO.BaO, and La₂O₃.2SiO₂ are indicated by “A”, “B”, “C”, and “D”, respectively, in the above tables.

As is evident from the tables, Samples Nos. 1 to 9, which are examples of the present invention, had large differences of 90° C. or more between the softening point and the crystallization temperature and therefore exhibited excellent fluidity during firing. Furthermore, these samples precipitated high-expansion crystals and exhibited coefficients of thermal expansion as high as 88 to 114×10⁻⁷/° C. In addition, it can be seen that the precipitated crystals had high melting points and the samples therefore also exhibited excellent thermal resistance. On the other hand, Sample No. 10, which is a comparative example, had a small difference of 10° C. between the softening point and the crystallization temperature and therefore exhibited poor fluidity during firing. Sample No. 11 precipitated no high-expansion crystals through the thermal treatment, therefore exhibited a coefficient of thermal expansion as low as 56×10⁻⁷/° C., and can be considered to have had poor thermal resistance.

### INDUSTRIAL APPLICABILITY

The crystallizable glass composition according to the present invention is suitable as an adhesive material for metals, such as SUS and Fe, and high-expansion ceramics, such as ferrite and zirconia. In particular, the crystallizable glass composition is suitable as an adhesive material for hermetically sealing a support substrate, an electrode member, and other members which are used in producing an SOFC. Furthermore, the crystallizable glass composition according to the present invention can be used not only for bonding application but also for other purposes, such as coating and filling. Specifically, the crystallizable glass composition can be used for a thermistor, a hybrid IC, and like applications.

### REFERENCE SIGNS LIST

1 electrolyte
2 anode
3 cathode
4 first support substrate
4a fuel channel 4a
5 second support substrate
5a air channel 5a

1. A crystallizable glass composition containing, in % by mole, over 57 to 80% SiO₂+CaO, over 0 to 40% MgO+BaO, over 10 to 40% ZnO, and over 0 to 15% La₂O₃.

2. The crystallizable glass composition according to claim 1, being substantially free of R₂O (where R represents an alkali metal) and P₂O₅.

3. The crystallizable glass composition according to claim 1, wherein the crystallizable glass composition precipitates crystals of at least one selected from the group consisting of MgO.SiO₂, BaO.2MgO.2SiO₂, 2SiO₂.2ZnO.BaO, and La₂O₃.2SiO₂ under thermal treatment.

4. The crystallizable glass composition according to claim 1, having a coefficient of thermal expansion of 85×10⁻⁷/° C. or more in a temperature range from 30 to 950° C.

5. The crystallizable glass composition according to claim 1, having a difference of 85° C. or more between a softening point thereof and a crystallization temperature thereof.

6. The crystallizable glass composition according to claim 1, containing, in % by mole, 40 to 70% SiO₂, 5 to 40% MgO, 5 to 40% BaO, 5 to 40% ZnO, 3 to 30% CaO, and over 0 to 15% La₂O₃.

7. The crystallizable glass composition according to claim 1, being used for bonding.
